(19) United States
(12) Patent Application Publication
(10) Pub. No.: US 2009/0241819 A1
(43) Pub. Date: Oct. 1, 2009

(54) Device for coloring a thread body, and sewing machine having the same

(75) Inventor: Shui-Chun TSENG, Taichung Hsien (TW)

Correspondence Address: PILLSBURY WINTHROP SHAW PITTMAN, LLP, P.O. BOX 10500, MCLEAN, VA, 22102, US

(73) Assignee: ZENG HSING INDUSTRIAL CO., LTD., Taiping City (TW)

(21) Appl. No.: 12/078,306

(22) Filed: Mar. 28, 2008

(51) Int. Cl. D05B 19/00; B05C 11/00

(52) U.S. Cl. 112/470.05; 118/669; 118/674

(57) ABSTRACT

A device for coloring a thread body includes a thread-feeding unit adapted for feeding the thread body at a predetermined speed such that the thread body is transported along a feeding path. A coloring unit is disposed fixedly adjacent to the feeding path, and is operable so as to spray a coloring material onto the thread body. A control unit is connected electrically to the coloring unit, and is operable so as to control the coloring unit to spray the coloring material, which has a desired one of a plurality of different colors.

### BACKGROUND OF THE INVENTION

1. Field of the Invention

The invention relates to a coloring device, more particularly to a device for coloring a thread body.

2. Description of the Related Art

FIG. 1 illustrates a conventional coloring device for a thread body 1 disclosed in Japan Patent Publication No. 05-124840. The conventional coloring device includes a hollow cylindrical main body 2 and a plurality of supply pipes 3. The cylindrical main body 2 has opposite open ends closed respectively by two plates. Each plate is formed with a plurality of through holes 201 permitting extension of the thread body 1 and the supply pipes 3 therethrough so that the spray pipes 3 and the thread body 1 are attached in an inner space in the cylindrical main body 2. A coloring material is sprayed in the inner space in the cylindrical main body 2 from the supply pipes 3 via fine spray holes in the supply pipes 3.

However, in the conventional coloring device, the coloring material coated on a segment of the thread body 1 disposed in the inner space in the cylindrical main body 2 has a single specific color during a spray period. In other words, the segment of the thread body 1 disposed in the inner space in the cylindrical main body 2 cannot present various colors. Therefore, the conventional coloring device cannot properly achieve color variation.

### SUMMARY OF THE INVENTION

Therefore, the object of the present invention is to provide a device for coloring a thread body that can overcome the aforesaid drawbacks of the prior art.

According to one aspect of the present invention, there is provided a device for coloring a thread body. The device comprises:

a thread-feeding unit adapted for feeding the thread body at a predetermined speed such that the thread body is transported along a feeding path;

a coloring unit disposed fixedly adjacent to the feeding path and operable so as to spray a coloring material onto the thread body; and

a control unit connected electrically to the coloring unit and operable so as to control the coloring unit to spray the coloring material, which has a desired one of a plurality of different colors.

According to another aspect of the present invention, a sewing machine comprises:

a housing;

a thread-feeding unit mounted on the housing and adapted for feeding a thread body at a predetermined speed such that the thread body is transported along a feeding path;

a coloring unit mounted fixedly in the housing, disposed adjacent to the feeding path, and operable so as to spray a coloring material onto the thread body; and

a control unit mounted in the housing, connected electrically to the coloring unit, and operable so as to control the coloring unit to spray the coloring material, which has a desired one of a plurality of different colors.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary perspective view of a conventional coloring device for a thread body;

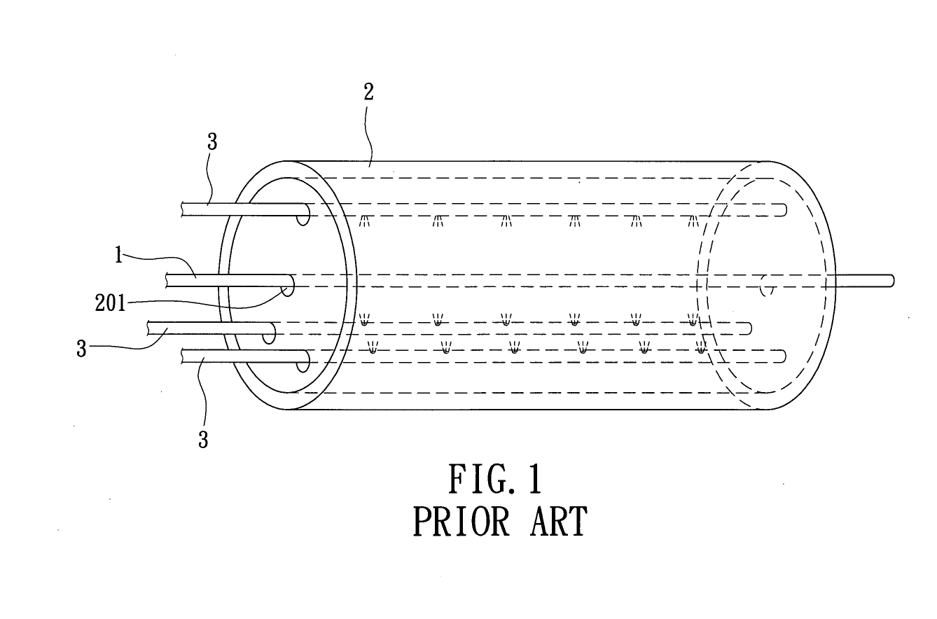

FIG. 2 is a schematic circuit block diagram illustrating the preferred embodiment of a device for coloring a thread body according to the present invention;

FIG. 3 is a schematic view showing the preferred embodiment; and

FIG. 4 is a fragmentary, partly cutaway, schematic front view showing the preferred embodiment incorporated with a sewing machine.

### DETAILED DESCRIPTION OF THE PREFERRED EMBODIMENT

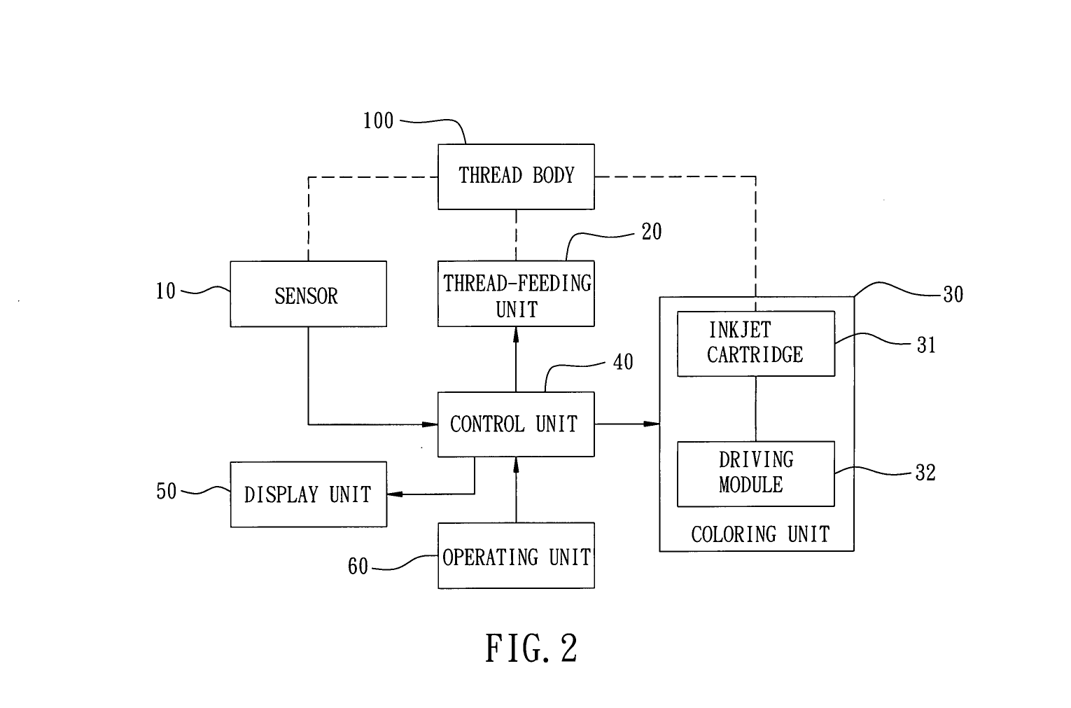

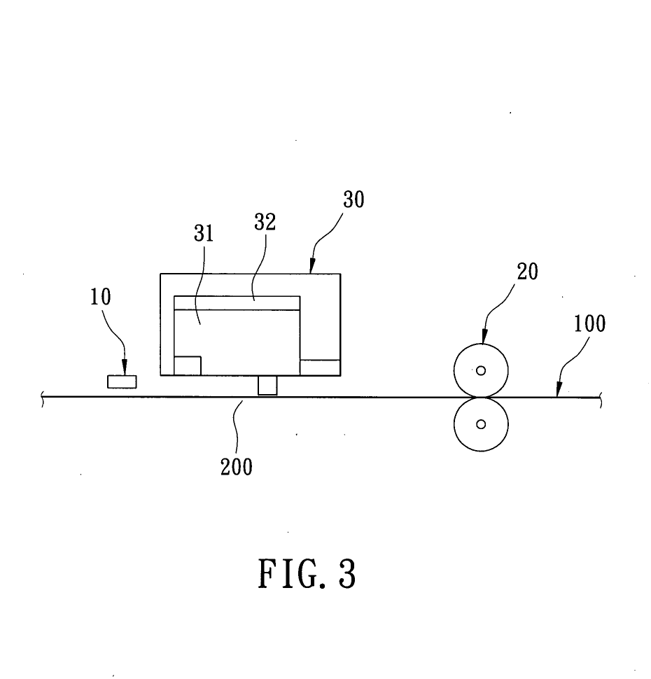

Referring to FIGS. 2 and 3, the preferred embodiment of a device for coloring a thread body 100 according to the present invention is shown to include a thread-feeding unit 20, a coloring unit 30, a control unit 40, a display unit 50, an operating unit 60, and a sensor 10.

The thread-feeding unit 20 is adapted for feeding the thread body 100 at a predetermined speed such that the thread body 100 is transported along a feeding path 200.

The coloring unit 30 is disposed fixedly adjacent to the feeding path 200, and is operable so as to spray a coloring material onto the thread body 100. In this embodiment, the coloring unit 30 includes a driving module 32, and an inkjet cartridge 31 driven by the driving module 32 so as to spray the coloring material onto the thread body 100. In this embodiment, the inkjet cartridge 31 is a color inkjet cartridge.

The control unit 40 is connected electrically to the coloring unit 30, and is operable so as to control the coloring unit 30 to spray the coloring material having a desired one of a plurality of different colors. In this embodiment, the circuit unit 40 is an integrated circuit.

The display unit 50 is connected electrically to the control unit 40 for displaying color information corresponding to the different colors and status information indicating the desired one of the different colors in the form of text or pictures.

The operating unit 60 is connected electrically to the control unit 40, and is operable so as to output a control signal corresponding to the desired one of the different colors to the control unit 40 so that the control unit 40 controls the coloring unit 30 to spray the coloring material having the desired one of the different colors based on the control signal from the operating unit 60.

The sensor 10 is connected electrically to the control unit 40, and is adapted to be disposed adjacent to the feeding path 200 for sensing movement of the thread body 100. The sensor 10 outputs a detecting signal to the control unit 40 upon detecting that the thread body 100 ceases to move so that the control unit 40 deactivates the coloring unit 30 based on the detecting signal from the sensor 10.

By properly controlling the coloring unit 30 by the control unit 40, color variation can be achieved on a segment of the thread body 100.

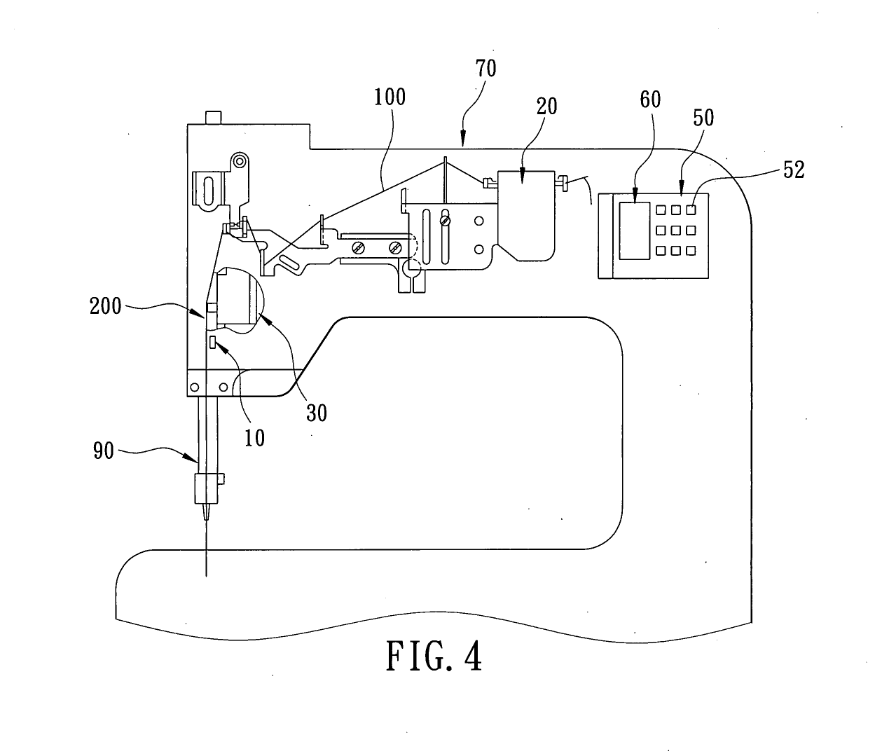

Referring to FIG. 4, the device of the preferred embodiment is incorporated with a sewing machine. The sewing machine includes a housing 70, and a driving unit 90 for driving stitching operation. The thread-feeding unit 20, the display unit 60, the operating unit 50 and the sensor 60 are mounted on the housing 70. The coloring unit 30 is mounted fixedly in the housing 70. The control unit 40 (not shown in FIG. 4) is mounted in the housing 70. The feeding path 200 is configured by a plurality of components on the housing 70. In this embodiment, the operating unit 50 includes a plurality of operating keys 52. One of the operating keys 52 is operable so as to generate the control signal. Therefore, during a color-stitching operation, the sewing machine can achieve color variation on the thread body 100 by operating properly the operating unit 50 without the need for replacement of the thread body 100, thereby resulting in convenience during use.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A device for coloring a thread body, comprising:
a thread-feeding unit adapted for feeding the thread body at a predetermined speed such that the thread body is transported along a feeding path;
a coloring unit disposed fixedly adjacent to the feeding path and operable so as to spray a coloring material onto the thread body; and
a control unit connected electrically to said coloring unit and operable so as to control said coloring unit to spray the coloring material, which has a desired one of a plurality of different colors.

2. The device as claimed in claim 1, further comprising:
a display unit connected electrically to said control unit for displaying color information corresponding to the different colors and status information indicating the desired one of the different colors; and
an operating unit connected electrically to said control unit and operable so as to output a control signal corresponding to the desired one of the different colors to said control unit so that said control unit controls said coloring unit to spray the coloring material having the desired one of the different colors based on the control signal from the operating unit.

3. The device as claimed in claim 1, further comprising a sensor connected electrically to said control unit and adapted to be disposed adjacent to the feeding path for sensing movement of the thread body, said sensor outputting a detecting signal to said control unit upon detecting that the thread body ceases to move so that said control unit deactivates said coloring unit based on the detecting signal from said sensor.

4. A sewing machine comprising:
a housing;
a thread-feeding unit mounted on said housing and adapted for feeding a thread body at a predetermined speed such that the thread body is transported along a feeding path;
a coloring unit mounted fixedly in said housing, disposed adjacent to the feeding path, and operable so as to spray a coloring material onto the thread body; and
a control unit mounted in said housing, connected electrically to said coloring unit, and operable so as to control said coloring unit to spray the coloring material, which has a desired one of a plurality of different colors.

5. The sewing machine as claimed in claim 4, further comprising:
a display unit mounted on said housing and connected electrically to said control unit for displaying color information corresponding to the different colors and status information indicating the desired one of the different colors; and
an operating unit mounted on said housing, connected electrically to said control unit, and operable so as to output a control signal corresponding to the desired one of the different colors to said control unit so that said control unit controls said coloring unit to spray the coloring material having the desired one of the different colors based on the control signal from the operating unit.

6. The device as claimed in claim 4, wherein said coloring device further includes a sensor mounted on said housing, connected electrically to said control unit and disposed adjacent to the feeding path for sensing movement of the thread body, said sensor outputting a detecting signal to said control unit upon detecting that the thread body ceases to move so that said control unit deactivates said coloring unit based on the detecting signal from said sensor.
